(19) United States
(12) Patent Application Publication
(10) Pub. No.: US 2009/0112825 A1
(43) Pub. Date: Apr. 30, 2009

(54) ENTITY RELATION MINING APPARATUS AND METHOD

(75) Inventors: Liqin XU, Beijing (CN); Changjian HU, Beijing (CN); Toshikazu FUKUSHIMA, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD, Beijing (CN)

(21) Appl. No.: 12/261,852

(22) Filed: Oct. 30, 2008

(30) Foreign Application Priority Data
Oct. 31, 2007 (CN) 2007-10167974.9

(51) Int. Cl. G06F 7/06; G06F 17/30

(52) U.S. Cl. 707/3; 707/E17.014

(57) ABSTRACT

The present invention provides a relation mining apparatus and method for mining data for time-series relations and events among texts in various forms such as news, blogs, industrial reports and technical papers which may refer to various relations. According to the present invention, it is possible to automatically extract entity relation instances from a large amount of the texts as described above originating from the Internet or other mediums, mine for time-series entity relations, relation scores and entity importances in various categories based on the extracted instances, and finally extract important events therefrom. Also, according to the present invention, it is possible to perform calculating on the above extracted time-series relations for the corporation entities and business relations, so as to achieve an analysis on Five Forces. Further, it is also possible to present the result to final users by a visualizing module.

### BACKGROUND OF THE INVENTION

1. Field of Invention

The present invention relates to the data mining field, more particularly, to an entity relation mining apparatus and method for mining data for time-series relations and events among texts in various forms such as news, blogs, industrial reports and technical papers which may refer to various relations. More advantageously, the present invention is applicable to the field of corporation business relations, for mining data for time-series business relations and business events.

2. Description of Prior Art

With the rapid development of globalization, more complicated business relations are formed among corporations than ever. Further, a developing process of a corporation is much faster than ever, during which other corporations having business relations with it play a critical role in its development.

On the other hand, with developing of informatization, a large amount of business news occurs in mediums such as Internet. These pieces of business news contain a lot of information about business relations among corporations. All the business news accumulated heretofore may cover almost all the information about business relations in all trades. There pieces of information form a time-series business information process. If a business consultation trade may obtain the information therefrom, create a time-series business information process from the information, and derive some business events useful for users, which mainly are corporation consulters, including business relation modes among corporations, business relation developing modes of corporations who develop rapidly, and business relation developing modes of corporations of importance in industrial chains and the like, then it is a promising technology.

How to extract these business relations, the time-series developing processes of the business relations and the business events from the large amount of news? It is impractical to carry out tracing and analyzing manually. The current scale of information means an impossible task for manpower.

It is the only feasible way to perform extracting by automatic program device. The problem to be solved by this device is to trace a large amount of news and extract the business relations therefrom, and then achieve the time-series corporation business relations and business events for final presenting.

There is no complete solution of the above problem in the art until now, but there are only technologies for solution of some sub-problems. For example, a technology is proposed by Japanese Patent No. 2006-195535 for extracting business relation instances from the text news. Each of the business relation instances is a “snapshot” of a certain business relation between certain corporations in one piece of news. However, this patent has not proposed how to perform further time-series data mining and business event mining on these instances.

The reference 1, E Keogh & S Kasetty, On the Need for Time Series Data Mining Benchmarks: A Survey and Empirical Demonstration, Data Mining and Knowledge Discovery, 7(4), 2003, has summarized many technologies for time-series data mining. However, it has neither proposed technologies of mining for business events, nor technologies of performing processing when the business relations are time-series data of mesh structure.

### SUMMARY OF THE INVENTION

The present invention mainly relates to mining data for time-series relations and events among texts in various forms such as news, blogs, industrial reports and technical papers which may refer to various relations. According to the present invention, it is possible to automatically extract various kinds of entity relation instances from a large amount of the texts as described above originating from the Internet or other mediums, and mine for time-series entity relations based on the extracted instances. It is also possible to mine for entity relation scores and importances of the entities in all categories, and finally extract important events therefrom. Also, according to the present invention, it is possible to perform calculating on the above extracted time-series relations for the corporation entities and business relations, so as to achieve an analysis on Five Forces. Further, it is also possible to present the result to final users by a visualizing module.

To achieve the above object, the present invention provides an entity relation mining apparatus comprising: a time-series entity relation extracting means for reading entity relation instances to generate time-series scored entity relations.

Preferably, the time-series entity relation extracting means further generates time-series comprehensive entity relation scores based on the generated time-series scored entity relations.

Preferably, the entity relation mining apparatus further comprises a time-series entity importance extracting means for reading the time-series comprehensive entity relation scores generated by the time-series entity relation extracting means to generate time-series entity importances.

Preferably, the entity relation mining apparatus further comprises an event detecting means for reading the time-series entity relations and the time-series comprehensive entity relation scores generated by the time-series entity relation extracting means to generate events.

Preferably, the entity relation mining apparatus further comprises an event detecting means for reading the time-series entity relations, the time-series comprehensive entity relation scores, and the time-series entity importances generated by the time-series entity relation extracting means and the time-series entity importance extracting means respectively to generate events.

Preferably, the entity relation mining apparatus further comprises a relation instance extracting means for reading text information data to generate the entity relation instances.

Preferably, the time-series entity relation extracting means comprises a time-series interpolating unit for calculating a score of an entity relation by interpolation for the entity relation within a prescribed time duration during which no entity relation occurs so that finally any one of continuous relations between any entities within the prescribed time duration has its score at any time point.

Preferably, the entities are corporations, and the relations are business relations. More preferably, the entity relation mining apparatus further comprises a time-series Five Force analyzing means for generating time-series force data based on the time-series entity relations and the time-series entity importances. Preferably, the entities are products, persons or nations, and the relations are relations among products, human relations or relations among nations.

Preferably, the entity relation mining apparatus further comprises a visualizing means for generating a visualized interface based on at least one of the time-series entity relations, the time-series comprehensive entity relation scores, the time-series entity importances, and the time-series force data.

To achieve the above object, the present invention provides an entity relation mining method comprising a time-series entity relation extracting step of reading entity relation instances to generate time-series scored entity relations.

Preferably, in the time-series entity relation extracting step, time-series comprehensive entity relation scores are further generated based on the generated time-series scored entity relations.

Preferably, the entity relation mining method further comprises a time-series entity importance extracting step of reading the time-series comprehensive entity relation scores generated in the time-series entity relation extracting step to generate time-series entity importances.

Preferably, the entity relation mining method further comprises an event detecting step of reading the time-series entity relations and the time-series comprehensive entity relation scores generated in the time-series entity relation extracting step to generate events.

Preferably, the entity relation mining method further comprises an event detecting step of reading the time-series entity relations, the time-series comprehensive entity relation scores, and the time-series entity importances generated in the time-series entity relation extracting step and the time-series entity importance extracting step respectively to generate events.

Preferably, the entity relation mining method further comprises a relation instance extracting step of reading text information data to generate the entity relation instances.

Preferably, the time-series entity relation extracting step comprises a time-series interpolating sub-step of calculating a score of an entity relation by interpolation for the entity relation within a prescribed time duration during which no entity relation occurs so that finally any one of continuous relations between any entities within the prescribed time duration has its score at any time point.

Preferably, the entities are corporations, and the relations are business relations. More preferably, the entity relation mining method further comprises a time-series Five Force analyzing step of generating time-series force data based on the time-series entity relations and the time-series entity importances.

Preferably, the entities are products, persons or nations, and the relations are relations among products, human relations or relations among nations.

Preferably, the entity relation mining method further comprises a visualizing step of generating a visualized interface based on at least one of the time-series entity relations, the time-series comprehensive entity relation scores, the time-series entity importances, and the time-series force data.

According to the present invention, the following technical problems are effectively solved: extracting the entity relations from the mass information and performing automatic time-series data mining; tracing the mass time-series entity relations and finally mining for the effective events; obtaining the analysis on Five Forces based on the mass time-series entity relations; and visually presenting the above mined entity information.

### BRIEF DESCRIPTION OF THE DRAWINGS

The above and further objects, features and advantages of the present invention will be more apparent from the following description of the preferred embodiments thereof with reference to the drawings, wherein:

FIG. 1 is a block diagram showing a corporation business relation mining system.

FIG. 2a is a block diagram and also a data flow chart showing a corporation business relation mining module 2 according to a first embodiment of the present invention; FIG. 2b is a block diagram and also a data flow chart showing the corporation business relation mining module 2 according to a second embodiment of the present invention; and FIG. 2c is a block diagram and also a data flow chart showing the corporation business relation mining module 2 according to a third embodiment of the present invention.

FIG. 3 is a block diagram and also a data flow chart showing a time-series corporation relation extracting sub-module 22.

FIG. 4a is a block diagram and also a data flow diagram showing a time-series corporation business importance extracting sub-module 23; and FIG. 4b is another block diagram and also data flow chart showing the time-series corporation business importance extracting sub-module 23.

FIG. 5a is a block diagram and also a data flow chart showing a business event detecting sub-module 24; and FIG. 5b is another block diagram and also data flow chart showing the business event detecting sub-module 24.

FIG. 6 is a block diagram and also a data flow chart showing a time-series Five Force analyzing sub-module 25.

FIG. 7 is a block diagram and also a data flow chart showing a visualizing module 4.

FIGS. 8a and 8b show an example of generating a basic graph.

### DETAILED DESCRIPTION OF PREFERRED EMBODIMENTS

The preferred embodiments of the present invention are described in detail hereinafter with reference to the drawings. Details and functions which are not necessary for the present invention are omitted so as not to confuse the understanding of the present invention. Further, in the following description, a relation mining apparatus and method according to the present invention are described in detail with corporations as an example of the entities and business relations as an example of the relations. It is to be noted, however, that the entities set forth in the present invention are not limited to the corporations, and may represent entities such as natural persons, nations or products. Accordingly, the relations set forth in the present invention are not limited to the business relations, and may be applicable to other social relations such as human relations and relations among nations.

### System Description Based on Corporations as Entities

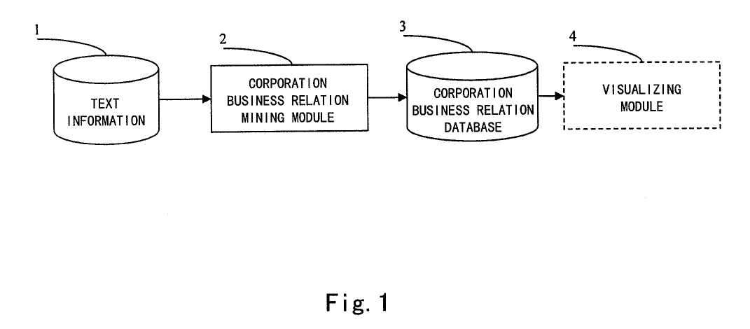

FIG. 1 is a block diagram showing a corporation business relation mining system. The reference symbol 1 denotes text information data placed in a database, which may be texts in various forms such as news, blogs, industrial reports and technical papers which may refer to the business relations or data sources in other forms which may be converted into texts. The reference symbol 2 denotes an entity relation mining apparatus according to the present invention. This apparatus reads the text information data 1 for mining for the corporation business relations, and finally generates relation data in various presenting forms which is then stored in a corporation business relation database 3. A visualizing module 4 reads the data in the corporation business relation database 3 so as to generate a visualized interface, wherein the visualizing module 4 may be provided inside or outside the entity relation mining apparatus 2 to achieve the function of generating the visualized interface.

### Corporation Business Relation Mining Apparatus

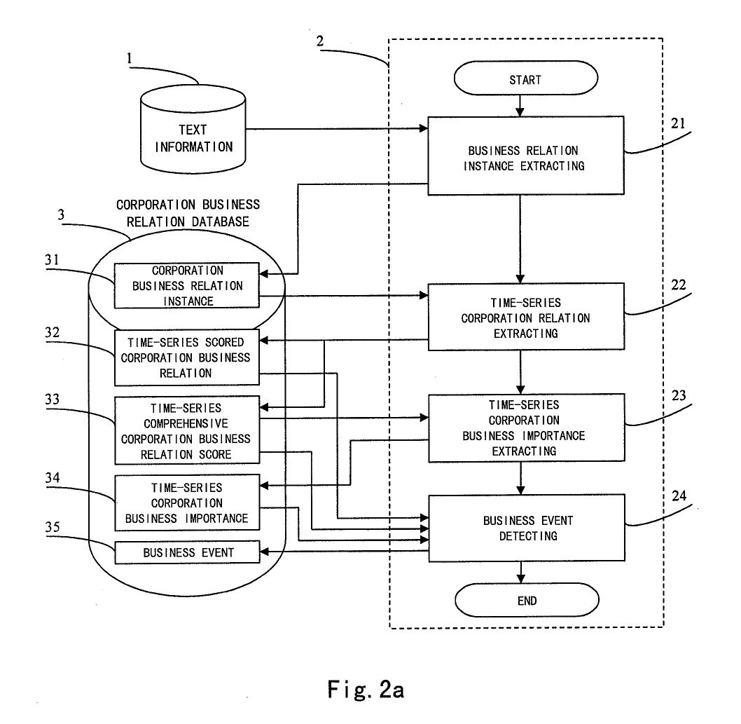

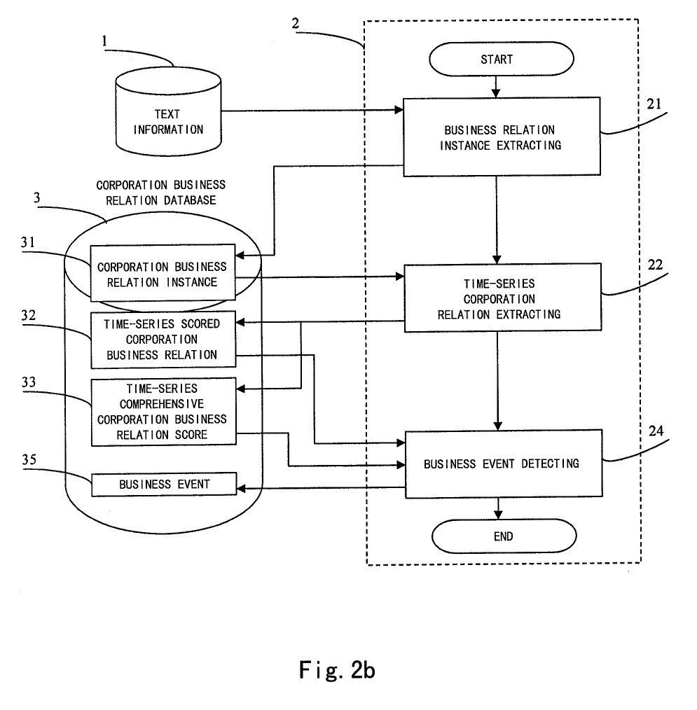

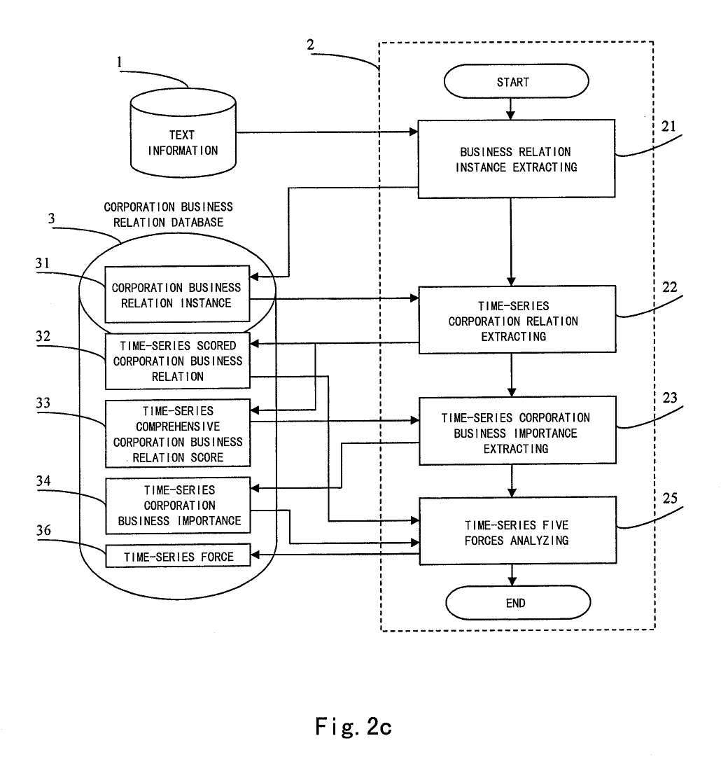

FIG. 2a is a block diagram and also a data flow chart showing the corporation business relation mining module 2 according to a first embodiment of the present invention. In the present embodiment, the corporation business relation mining module 2 may be divided into four sub-modules comprising: a business relation instance extracting sub-module 21 for reading the text information data 1 so as to generate a corporation business relation instance 31, which module is an optional module and may be implemented in a manner other than that described in the embodiments; a time-series corporation relation extracting sub-module 22 for reading the corporation business relation instance 31 generated by the business relation instance extracting sub-module 21 so as to generate a time-series scored corporation business relation 32 and a time-series comprehensive corporation business relation score 33; a time-series corporation business importance extracting sub-module 23 for reading the time-series comprehensive corporation business relation score 33 generated by the time-series corporation relation extracting sub-module 22 so as to generate a time-series corporation business importance 34; and a business event detecting sub-module 24 for reading the time-series scored corporation business relation 32, the time-series comprehensive corporation business relation score 33, and the time-series corporation business importance 34 generated by the time-series corporation relation extracting sub-module 22 and the time-series corporation business importance extracting sub-module 23 respectively, so as to generate a business event 35.

The text information 1 comprises a content, an issuing time and an optional source (for example, from which web it is obtained). It is of the following data structure.

TABLE 1
data structure of news
Time
Content
Source (optional)

The corporation relation instance 31 is a certain business relation between two corporations mentioned in the text information 1, and is of the following data structure.

TABLE 2
example of data structure of corporation relation instance
Corporation A
Corporation B
Type of relation
Date
Source (optional)

The type of relation may be competition, cooperation, share holding, supply, incorporation, acquisition and so on. In the following expressions, RI(A,B,X,t′) is used to denote a corporation relation instance, which means that there is a business relation instance X between corporation A and corporation B on date of t′.

The time-series scored corporation business relation 32 refers to that there are a certain time-series business relation and a score thereof between two corporations during a given period, wherein the score is credibility at which there exists this relation during such time unit. Specifically, in each time unit (here, one month) within this period, the two corporations both hold this business relation and the corresponding score. The higher is the score, more credible is the relation. When the score is 0, it means that there is no such relation. An example of its data structure is shown in Table 3.

TABLE 3
example of data structure of time-series scored corporation business
relation
Corporation A
Corporation B
Type of relation
{(month, score), (month, score), . . . }

s_{A,B,X}(t) is used to denote the score for the business relation X between corporation A and corporation B in the time unit t.

Table 4 shows two examples, where the given period is from March 2000 to September 2007.

TABLE 4
examples of time-series scored corporation business relation

| Corporation A | Corporation A |
|---|---|
| Corporation B | Corporation B |
| Competition | Cooperation |
| {(2000/3, 0.8), | {(2000/3, 0), . . . , |
| (2000/4, 0.6) . . . (2007/9, 0.01)} | (2000/6, 0.9) . . . (2007/9, 0.01)} |

The time-series comprehensive corporation business relation score 33 refers to that there is a time-series comprehensive business relation score between two corporations during a given period as well as a total business relation score during this period derived therefrom. The total business relation score is an average of the time-series relation scores. An example of its data structure is shown as follows.

TABLE 5
example of data structure of time-series comprehensive corporation
business relation score
Corporation A
Corporation B
Total business relation score
{(month, business relation score), (month, business relation score), . . . }

s_{A,B}(t) is used to denote the business relation score between corporation A and corporation B within time t, and s_{A,B} to denote the total business relation score between corporation A and corporation B. Table 6 shows an example.

TABLE 6
example of time-series comprehensive corporation business relation score
Corporation A
Corporation B
0.8
{(2000/3, 0.7), (2000/6, 0.9), . . . (2007/9, 0.01)}

The time-series corporation business importance 34 refers to the time-series business importance of a corporation during a given period. The business importance means the importance of one corporation in its own trade or across trades. Its data structure is shown as follows.

TABLE 7
example of data structure of time-series corporation business importance
Corporation A
{(month, business importance), (month, business importance), . . . }

s_{A}(t) is used to denote the business importance of corporation A within time t.

The business event 35 refers to an event derivable from the above data, which is effective and has heuristic meanings for users or other corporations. The business events may be categorized into simple events and complex events. The simple event refers to an event-like business relation occurring among the corporations, which may be obtained directly from the time-series scored corporation business relation 32. For example, corporation A acquired corporation B in January 2000. The complex event refers to a high-level event derived from a trade analyzing perspective, which has heuristic meanings for users or other corporations. These events cannot be derived directly, and can only be derived by analyzing the time-series scored corporation business relation 32, the time-series comprehensive corporation business relation score 33 and the time-series corporation business importance 34. For example, corporation A was a core corporation in its trade from January 1998 to January 2001; corporation B had developed rapidly from January 1999 to January 2000; corporation C had deteriorated from January 2004 to January 2005; A and B had developed rapidly from March 1999 to January 2000; and the relation between C and D had deteriorated from March 2004 to January 2005.

### Business Relation Instance Extracting Sub-Module 21

The business relation instance extracting sub-module 21 may be implemented by prior art, such as a method proposed in Japanese Patent No. 2006-195535.

### Time-Series Corporation Relation Extracting Sub-Module 22

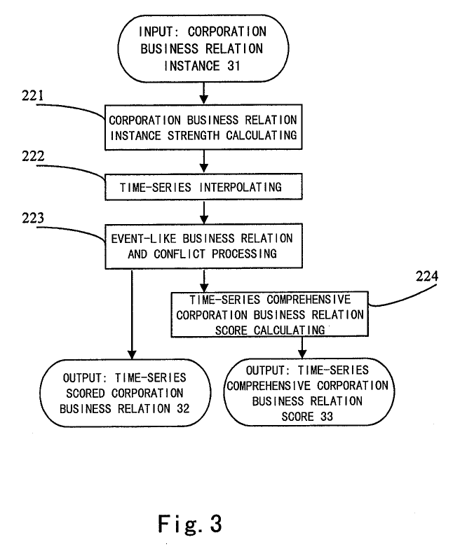

FIG. 3 is a block diagram and also a data flow chart showing the time-series corporation relation extracting sub-module 22.

A corporation business relation instance strength calculating unit 221 calculates a strength SI(A,B,X,t) of the corporation business relation of A, B, X within a corresponding time unit of t based on each corporation business relation instance RI(A,B,X,t′).

Within the time unit of t, the corporation business relation instance A, B, X may occur several times. For example, it may be mentioned in different news webs, and may be mentioned several times within t. Cₜ is used to denote the number of times the corporation business relation instance occurs within the time unit of t. Thus, SI(A,B,X,t) may be calculated by the following equation.

$$SI ( A , B , X , t ) = {si}_{A , B , X} ( t ) = {\sum }_{i = 1}^{{C}_{l}} m s ( {n}_{i} )$$

where nᵢ is a corresponding i^{th} instance, ms(nᵢ) is a matching score of the news of this instance. In fact, the strength is a sum of the scores of all the instants within the time unit of t.

A time-series interpolating unit 222 calculates a score of a corporation relation, for which no corporation business relation instant occurs during a prescribed period, by interpolation, so that finally any one of continuous relations between any corporations within the prescribed period has its score at any time point. The continuous corporation relation means that the relation continues for a period, while is not a one-time event-like relation. For example, the competition, cooperation, share holding and supply are all continuous business relations. For example, there was no competition relation between corporation A and corporation B in June 2000, but this relation had occurred before in January 2000. Then, the score in June 2000 is calculated by interpolation by using the preceding score of this relation. For example, the method for performing interpolation is as follows.

It is assumed that a relation RI between two corporations first occurs at to, and last occurs at tₘ.

For calculating the corporation relation strength at tₙ, it is assumed that an instance occurring just before tₙ occurs at tₖ, and an instance occurring just after tₙ occurs at t₁, then

$${s}_{A , B , X} ( {t}_{n} ) = \{ \begin{matrix}{si}_{A , B , X} ( {t}_{n} ) & RI ( A , B , X , {t}_{n} ) exist \\ 0 & {t}_{n} < {t}_{0} \\ {si}_{A , B , X} ( {t}_{m} ) \cdot {e}^{- λ ( {t}_{n} - {t}_{m} )} & {t}_{n} > {t}_{m} \\ \frac{{t}_{l} - {t}_{n}}{{t}_{l} - {t}_{k}} \cdot {si}_{A , B , X} ( {t}_{k} ) \cdot {e}^{- λ ( {t}_{n} - {t}_{k} )} + \frac{{t}_{n} - {t}_{k}}{{t}_{l} - {t}_{k}} \cdot {si}_{A , B , X} ( {t}_{l} ) \cdot {e}^{- λ ( {t}_{l} - {t}_{n} )} & {t}_{0} < {t}_{k} < {t}_{n} < {t}_{l} < {t}_{m}\end{matrix}$$

In the above example, the score of the relation exponentially decreases or increases over time. However, as is well-known to those skilled in the art, the variation may be linear decrease or increase over time.

An event-like business relation and conflict processing unit 223 processes the event-like business relations. The event-like business relations means one-time events rather than continuous business relations. For example, the incorporation and acquisition are both event-like business relations, while the competition, cooperation, share holding and supply are all continuous business relations. The process comprises processing of the scores of such relations per se, processing upon conflict, and processing of other affected relations. For example, the processing method is as follows.

First, the problem of conflict is handled. The solution of conflict is as follows.

Time conflict: Theoretically, the event-like relation should occur only once. However, the information on the Internet is not completely reliable. Therefore, there may be a conflict. If there is a conflict, that is, there are both RI(A,B,X,t₁) and RI(A,B,X,t₂) (t₁<t₂), then an adjusted new corporation relation strength is:

s_{A,B,X}(t₁)=si_{A,B,X}(t₁)+si_{A,B,X}(t₂)

s_{A,B,X}(t₂)=0

Direction conflict: The direction conflict deals specifically with directional event-like relations such as acquisition. For such relations, there is only one correct direction for two corporations. When there are both RI(A,B,X,t₁) and RI(B,A,X,t₂) (t₁<t₂), if

s_{A,B,X}(t₁)≧s_{B,A,X}(t₂),

then

s_{A,B,X}(t₁)=s_{A,B,X}(t₁);

s_{B,A,X}(t₂)=0

otherwise

s_{A,B,X}(t₁)=0.

s_{B,A,X}(t₂)=s_{B,A,X}(t₂)

Next, the influences on other business relations are handled. If X is a relation of incorporation or acquisition and s_{A,B,X}(t₁)>TH, where TH is a predetermined threshold, then A and B are acquired into one corporation after t₁, and there is no continuous relation maintained between A and B. After incorporation, the scores of the relations between corporation A (B) and other corporations are adjusted as follows.

s_{A,C,X}(t)=s_{A,C,X}(t)+s_{B,C,X}(t)

After completing the above process, the event-like business relation and conflict processing unit 223 outputs the time-series scored corporation business relation 32.

A time-series comprehensive corporation business relation score calculating unit 224 calculates the time-series comprehensive business relation score between two corporations and the average total business relation score. Specifically, a weighted average of the scores of the various relations is calculated so as to obtain the time-series comprehensive business relation score, that is

s_{A,B}(t)=Σw(X)·s_{A,B,X}(t)

where w(X) is the weight of respective relations, which may be an experience value or may be obtained by a statistical method. The statistical method may be that a probability that a relation occurs in each industry is counted to be used as the weight. Thereafter, the total business relation score is obtained by averaging over all the time. After the process described above, the time-series comprehensive corporation business relation score calculating unit 224 outputs the time-series comprehensive corporation business relation score 33.

Time-Series Corporation Business Importance Extracting Sub-Module 23

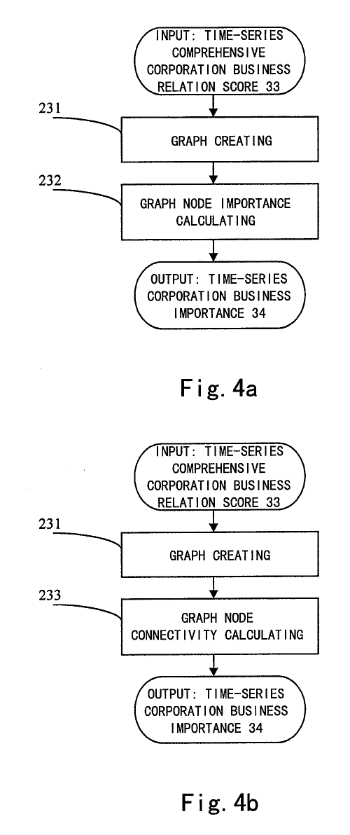

FIG. 4a is a block diagram and also a data flow diagram showing the time-series corporation business importance extracting sub-module 23. A graph creating unit 231 creates a graph for the corporations within each time unit. The vertices of the graph is the corporations, and the edges connecting the vertices are the comprehensive business relation scores 33 between respective two corporations. Thus, an undirected graph with weights is generated. A graph node importance calculating unit 232 calculates an importance for each node (that is, corporation) by using a graph node importance calculating method such as a Page Rank method or a HITS algorithm. The graph node importance calculating unit 232 outputs the time-series corporation business importance 34.

FIG. 4b is another block diagram and also data flow chart showing the time-series corporation business importance extracting sub-module 23.

A graph creating unit 231 creates a graph for the corporations within each time unit. The vertices of the graph is the corporations, and the edges connecting the vertices are the comprehensive business relation scores 33 between respective two corporations. Thus, an undirected graph with weights is generated.

A graph node connectivity calculating unit 233 calculates an importance for each node (that is, corporation) by using a conventional graph node connectivity calculating method, for example, a sum of the number of the connections to each node or a sum of the weights of the connections to each node. The graph node connectivity calculating unit 233 outputs the time-series corporation business importance 34.

Business Event Detecting Sub-Module 24

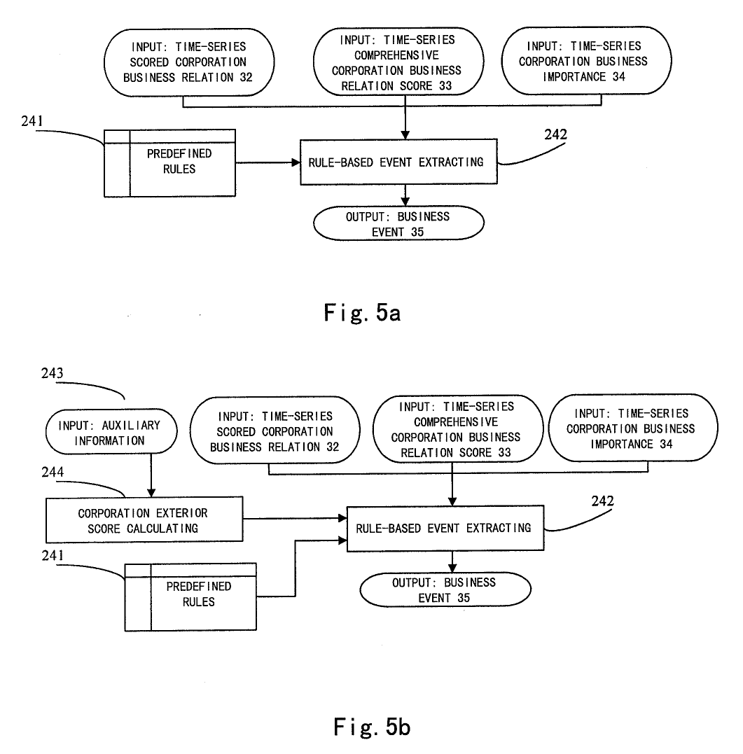

FIG. 5a is a block diagram and also a data flow chart showing the business event detecting sub-module 24.

A rule-based event extracting unit 242 detects all the input data using predefined rules 241, and outputs the business events mating the predefined rules 241. The predefined rules 241 may be predefined manually. Some examples of the rules are as follows.
The simple events are extracted directly from the time-series scored corporation business relation 32. Among others, for the acquisition event which requires further determination, there are two cases: corporation A may acquire corporation B, or may acquire a division of corporation B. These two cases may be determined based on the following criterion:
   If when corporation A acquires corporation B, the importance of corporation A is (1) much higher than that of corporation B, or (2) higher than that of corporation B and the importance of corporation B decreases continuously thereafter, then corporation A acquires corporation B;
   If the above conditions are not satisfied, then corporation A acquires a division of corporation B;
If the business importance of corporation A S_{A}(t)>Th₁,t₀≦t≦t₁, then A is a key corporation from t₀ to t₁;
For corporation A, if

$$\frac{{S}_{A} ( {t}_{1} ) - {S}_{A} ( {t}_{0} )}{{t}_{1} - {t}_{0}} > {Th}_{2} ,$$

then A has developed rapidly from t₀ to t₁;
For corporation A, if

$$\frac{{S}_{A} ( {t}_{0} ) - {S}_{A} ( {t}_{1} )}{{t}_{1} - {t}_{0}} > {Th}_{3} ,$$

then there is something wrong with A from t₀ to t₁;
For corporations A and B, if

$$\frac{{S}_{A , B} ( {t}_{1} ) - {S}_{A , B} ( {t}_{0} )}{{t}_{1} - {t}_{0}} > {Th}_{4} ,$$

then the relation between A and B has developed rapidly from t₀ to t₁;
For corporations A and B, if

$$\frac{{S}_{A , B} ( {t}_{0} ) - {S}_{A , B} ( {t}_{1} )}{{t}_{1} - {t}_{0}} > {Th}_{5} ,$$

then the relation between A and B has deteriorated from t₀ to t₁.

FIG. 5b is another block diagram and also data flow chart showing the business event detecting sub-module 24.

As compared with FIG. 5a, in FIG. 5b there are added auxiliary information 243 (some disclosed corporation information which is collected in advance, such as corporation sales and corporation profits) and a corporation exterior score calculating unit 244. The corporation exterior score calculating unit 244 performs any feasible simple calculation on the auxiliary information 243, for example, any feasible score calculation such as simple addition and weighted addition, so as to obtain the exterior scores for the corporations.

Here, the rules adopted by the rule-based event extracting unit 242 may comprise, in addition to the predefined rules 241 described with reference to FIG. 5a, the information on the corporation exterior scores obtained by the corporation exterior score calculating unit 244 using the auxiliary information 243. For example,
If the business importance of corporation A S_{A}(t)>Th₁,t₀≦t≦t₁, and the exterior score of A is higher than a threshold, then A is a key corporation from t₀ to t₁;
For corporation A, if

$$\frac{{S}_{A} ( {t}_{1} ) - {S}_{A} ( {t}_{0} )}{{t}_{1} - {t}_{0}} > {Th}_{2} ,$$

and the exterior score of A at time of t₁ is higher than a threshold, then A has developed rapidly from t₀ to t₁;
For corporation A, if

$$\frac{{S}_{A} ( {t}_{0} ) - {S}_{A} ( {t}_{!} )}{{t}_{1} - {t}_{0}} > {Th}_{3} ,$$

and the exterior score of A at time of t₁ is lower than a threshold, then there is something wrong with A from t₀ to t₁.

### SPECIFIC EXAMPLE

### Specific Output Results of the Time-Series Corporation Relation Extracting Sub-Module 22, the Time-Series Corporation Business Importance Extracting Sub-Module 23 and the Business Event Detecting Sub-Module 24

In the following, an example is given for the specific output results of the time-series corporation relation extracting sub-module 22, the time-series corporation business importance extracting sub-module 23 and the business event detecting sub-module 24.

The following example is directed to four corporations of A, B, C and D within a period of 2007.1.1-2007.7.31 (from Jan. 1, 2007 to Jul. 31, 2007) with a time unit of 1 month for the corporation relations.

The time-series corporation relation extracting sub-module 22 obtains the following corporation relation instances 31 from the news.

| Instance 1 | Instance 2 | Instance 3 | Instance 4 | Instance 5 | Instance 6 | Instance 6 |
|---|---|---|---|---|---|---|
| A | A | A | A | A | A | A |
| B | B | B | B | C | C | C |
| competition | competition | competition | cooperation | acquisition | competition | competition |
| 2007.1.8 | 2007.1.9 | 2007.3.2 | 2007.4.1 | 2007.5.8 | 2007.2.7 | 2007.5.9 |

| Instance 6 | Instance 7 | Instance 8 | Instance 9 | Instance 10 | Instance 11 | Instance 4 | Instance 5 |
|---|---|---|---|---|---|---|---|
| A | B | B | A | A | A | C | A |
| D | C | C | D | D | D | D | D |
| share | cooperation | cooperation | cooperation | cooperation | cooperation | competition | competition |
| holding | | | | | | | |
| 2007.6.9 | 2007.2.4 | 2007.2.5 | 2007.5.8 | 2007.5.9 | 2007.7.2 | 2007.6.1 | 2007.7.8 |

The instance strengths obtained by the corporation business relation instance strength calculating unit 221 are as follows, where the matching scores are given the value of 1.0.

| 2.0 | 1.0 | 1.0 | 1.0 | 1.0 | 1.0 |
|---|---|---|---|---|---|
| A | A | A | A | A | A |
| B | B | B | C | C | C |
| competition | competition | cooperation | acquisition | competition | competition |
| 2007.1 | 2007.3 | 2007.4 | 2007.5 | 2007.2 | 2007.5 |

| 1.0 | 2.0 | 2.0 | 1.0 | 1.0 | 1.0 |
|---|---|---|---|---|---|
| A | B | A | A | C | A |
| D | C | D | D | D | D |
| share holding | cooperation | cooperation | cooperation | competition | competition |
| 2007.6 | 2007.2 | 2007.5 | 2007.7 | 2007.6 | 2007.7 |

The interpolated corporation relations obtained by the time-series interpolating unit 222 are as follows, where λ=0.223144.

| A | A |
|---|---|
| B | B |
| competition | cooperation |
| {(2007/1, 2.0) (2007/2, 1.2) | {(2007/4, 1.0) (2007/5, 0.8) |
| (2007/3, 1.0) (2007/4, 0.8) | (2007/6, 0.64) |
| (2007/5, 0.64) (2007/6, 0.512) | (2007/7, 0.512)} |
| (2007/7, 0.4096)} | |

| | |
|---|---|
| A | A |
| C | C |
| acquisition | competition |
| {(2007/5, | {(2007/2, 1.0) (2007/3, 0.8) (2007/4, 0.8) (2007/5, 1.0) |
| 1.0)} | (2007/6, 0.8) (2007/7, 0.64)} |

| | |
|---|---|
| A | A |
| D | D |
| share holding | cooperation |
| {(2007/6, 1.0) (2007/7, 0.8)} | {(2007/5, 1.0) (2007/6, 0.8) (2007/7, 1.0)} |

| | |
|---|---|
| B | C |
| C | D |
| cooperation | competition |
| {(2007/2, 1.0) (2007/3, 0.8) (2007/4, 0.64) | {(2007/6, 1.0) |
| (2007/5, 0.512) (2007/6, 0.4906) (2007/7, 0.32768)} | (2007/7, 0.8)} |

The time-series scored corporation business relations 32 outputted from the event-like business relation and conflict processing unit 223 are as follows.

| A | A |
|---|---|
| B | B |
| competition | cooperation |
| {(2007/1, 2.0) (2007/2, 1.2) | {(2007/4, 1.0) |
| (2007/3, 1.0) (2007/4, 0.8) | (2007/5, 1.312) |
| (2007/5, 0.64) (2007/6, 0.512) (2007/7, 0.4096)} | (2007/6, 1.1306) |
| | (2007/7, 0.83968)} |

| A | A |
|---|---|
| C | C |
| acquisition | competition |
| {(2007/5, 1.0)} | {(2007/2, 1.0) (2007/3, 0.8) (2007/4, 0.8)} |
| A | A |
| D | D |
| share holding | cooperation |
| {(2007/6, 1.0) | {(2007/5, 1.0) (2007/6, 0.8) (2007/7, 1.0)} |
| (2007/7, 0.8)} | |

| | |
|---|---|
| B | A |
| C | D |
| cooperation | competition |
| {(2007/2, 1.0) (2007/3, 0.8) (2007/4, 0.64)} | {(2007/6, 1.0) |
| | (2007/7, 0.8)} |

The time-series comprehensive corporation business relation scores 33 obtained by the time-series comprehensive corporation business relation score calculating unit 224 are as follows, where the weights of the respective continuous relations are given the value of 1, and the weights of the event-like relations (acquisition, incorporation) are given the value of 0.

| A | A |
|---|---|
| B | C |
| 1.5497 | 0.65 |
| {(2007/1, 2.0) (2007/2, 1.2) | {(2007/1, 0) (2007/2, 1.0) |
| (2007/3, 1.0) (2007/4, 1.8) | (2007/3, 0.8) (2007/4, 0.8)} |
| (2007/5, 1.956) (2007/6, 1.6426) | |
| (2007/7, 1.24928)} | |

| | |
|---|---|
| A | B |
| D | C |
| 0.9143 | 0.61 |
| {(2007/1, 0) (2007/2, 0) | {(2007/1, 0) (2007/2, 1.0) |
| (2007/3, 0) (2007/4, 0) (2007/5,1.0) | (2007/3, 0.8) |
| 1.0) (2007/6, 2.8) (2007/7, 2.6)} | (2007/4, 0.64)} |

The time-series corporation business importances 34 calculated by the time-series corporation business importance extracting sub-module 23 (FIG. 4a) are as follows.

| A | B |
|---|---|
| {(2007/1, 1.4) (2007/2, 1.9) (2007/3, 1.5) | {(2007/1, 1.4) (2007/2, 1.9) |
| (2007/4, 2.1) (2007/5, 2.1) (2007/6, 3.1) | (2007/3, 1.5) (2007/4, 2.0) |
| (2007/7, 2.7)} | (2007/5, 1.9) (2007/6, 1.6) |
| | (2007/7, 1.2)} |
| C | D |
| {(2007/1, 0) (2007/2, 1.8) (2007/3, 1.4) | {(2007/1, 0) (2007/2, 0) |
| (2007/4, 1.3) (2007/5, 0) (2007/6, 0) | (2007/3, 0) (2007/4,1.8) |
| (2007/7, 0)} | (2007/5, 1.0) (2007/6, 2.7) |
| | (2007/7, 2.5)} |

The business event detecting sub-module 24 obtains the following events. A acquires C, 2007.5,

The relation between A and D has developed rapidly after 2007.5, and D has developed rapidly after 2007.6.

FIG. 2b is a block diagram and also a data flow chart showing the corporation business relation mining module 2 according to a second embodiment of the present invention. As compared with FIG. 2a, the time-series corporation business importance extracting sub-module 23 is eliminated. Therefore, the time-series corporation business importance 34 is no longer generated. Accordingly, the rules in the business event detecting sub-module 24 will not match any portion related to the time-series corporation business importance 34.

FIG. 2c is a block diagram and also a data flow chart showing the corporation business relation mining module 2 according to a third embodiment of the present invention. As compared with FIG. 2a, in FIG. 2c a time-series Five Force analyzing sub-module 25 is added. The time-series Five Forces analyzing sub-module 25 generates time-series force data 36.

Five Forces is proposed by Michael E. Porter (see Competitive Strategy, Free Press, 1980), which comprises five forces: threat of entry, power of supplier, competitive rivalry, power of buyer, and threat of substitute. The analysis on these five forces contributes greatly to improve the competitive forces of the corporations. There five forces are time-varying. Therefore, it is the time-series force data 36 that is stored in the corporation business relation database 3. The time-series Five Force analyzing sub-module 25 calculates the time-series force data 36 based on the time-series scored corporation business relation 32 and the time-series corporation business importance 34.

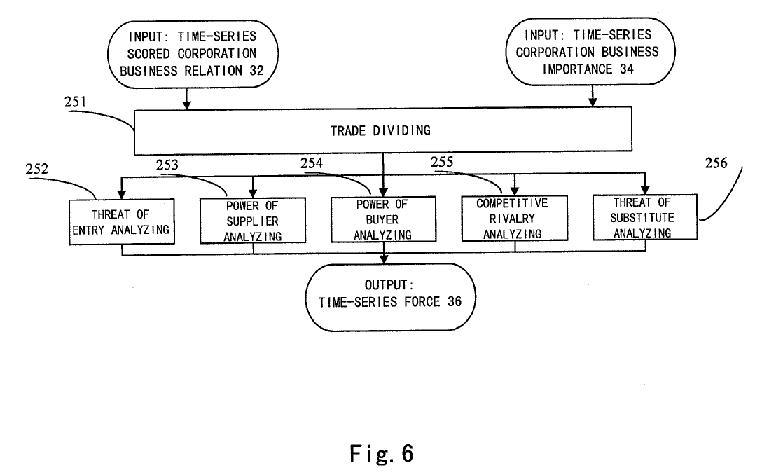

FIG. 6 is a block diagram and also a data flow chart showing the time-series Five Force analyzing sub-module 25.

The time-series Five Force analyzing sub-module 25 comprises 6 units, among which, a trade dividing unit 251 divides the input time-series scored corporation business relations 32 and time-series corporation business importances 34 based on a required trade, so as to output the time-series corporation business relations 32 and business importances 34 for the individual trade (that is, the required trade). The trade dividing unit 251 may carry out the above dividing by a lot of methods. A first method is that the time-series scored corporation business relations 32 and time-series corporation business importances 34 may be filtered using a known list of corporations. A second method is that the filtering may be carried out using a list of corporations given by the users. A third method is that the inputs for the respective trades are obtained by performing graph-based clustering on the trades. The reference symbols 252-256 denote five separate units for calculating the five forces respectively.

The threat of entry analyzing unit 252 operates as follows.

It calculates the threat of entry at time of to by selecting the corporations with business importance of 0 (that is, the corporations are non-existent or have not entered this trade) at and before to while with business importance greater than 0 from t₀ to +Δt. The score of the threat of entry is the number of such corporations. Instead, the business importance score of these corporations may be calculated.

The power of supplier analyzing unit 253 operates as follows.

It calculates the power of supplier at time of t₀ by obtaining all the supply relations at t₀ and summing up the scores of the supply relations of the supplier in this trade so as to generate the power of the supplier.

The power of buyer analyzing unit 254 operates as follows.

It calculates the power of buyer at time of t₀ by obtaining all the supply relations at t₀ and summing up the scores of the supply relations of the buyer in this trade so as to generate the power of the buyer.

The competitive rivalry analyzing unit 255 operates as follows.

It calculates the competitive rivalry at time of t₀ by obtaining all the competition relations of this trade at t₀ and calculating the accumulated scores as the result.

The threat of substitute analyzing unit 256 operates as follows.

First scheme: It calculates the threat of substitute at time of t₀. Since there is no product information in this system, it is impossible to achieve results of the threat of substitute analyzing. Here, we use a future competition trend in place of the threat of substitute. The future competition trend does not relate to the product information, and indicates all-round competitions that the corporation will potentially encounter in the future. All the competition relations which are non-existent at t₀ but are existent from t₀ to t₀+Δt are selected, and the scores are accumulated as the result.

Second scheme: The sub-trades corresponding to several kinds of products in this trade are selected manually, the competition relations between each product sub-trade and other product sub-trades at t₀ are selected, and the scores are accumulated as the result.

### Visualizing Module

The visualizing module 4 is provided for drawing the corporation business relations extracted according to the present invention as a business relation presenting view for user interaction. The user may perform the following operations on the business relation: retrieving and locating, viewing of variations in intervals of the business relation, synchronous displaying of the detected events, and constructing of inherent relations among various views. The visualizing module is an optional module, and the specific schemes for visualizing are not limited to those described in the present invention, and may be achieved by the prior schemes.

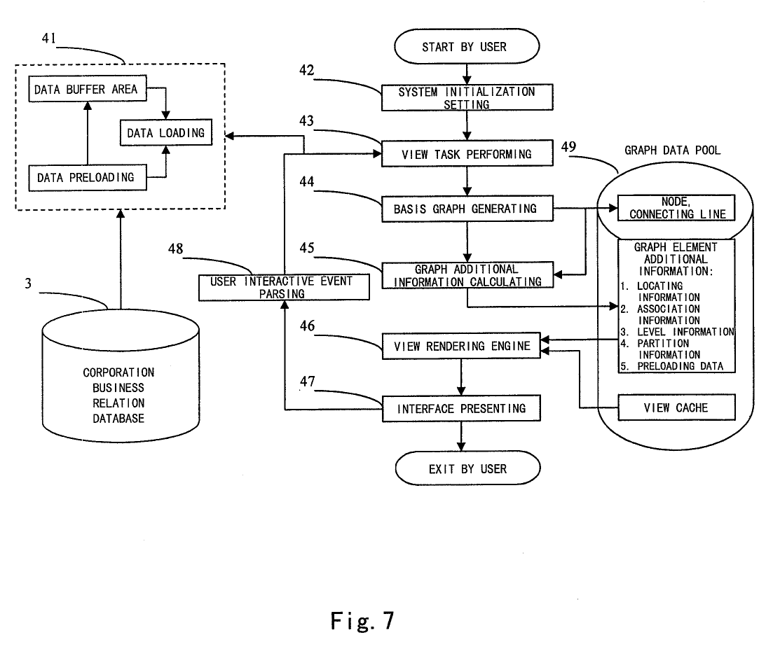

FIG. 7 is a block diagram and also a data flow chart showing the visualizing module 4.

A data buffer area+data loading+data preprocessing unit 41 is provided for fast loading data in the database, and storing it in the certain buffer area in blocks based on the time-series information, so that the system extracts the proper data information quickly. The input information to the data buffer area+data loading+data preprocessing unit 41 is all the information in the corporation business relation database 3, and the output information thereof depends on parsing of actual user interactive events, and mainly are combinations of the following three kinds of data:

1) the time-series corporation business importance 34;
2) the time-series scored corporation business relation 32; and
3) the business event 35.

A system initialization setting unit 42 generates a basis view task, and a user interactive event parsing unit 48 generates a series of view tasks. A view task performing unit 43 mainly performs the following two operations. One operation is description locating of the original data, which part may be parsed and from which the relevant data information may be extracted by the data buffer area+data loading+data preprocessing unit 41. The other operation is a series of algorithm calling flows corresponding to the task, such as generating a basis graph based on the extracted data, using which graph additional information calculating algorithm, using which view rendering method, and so on. The view task performing unit 43 is a view task engine for performing and directing the flow directions of the relevant view tasks.

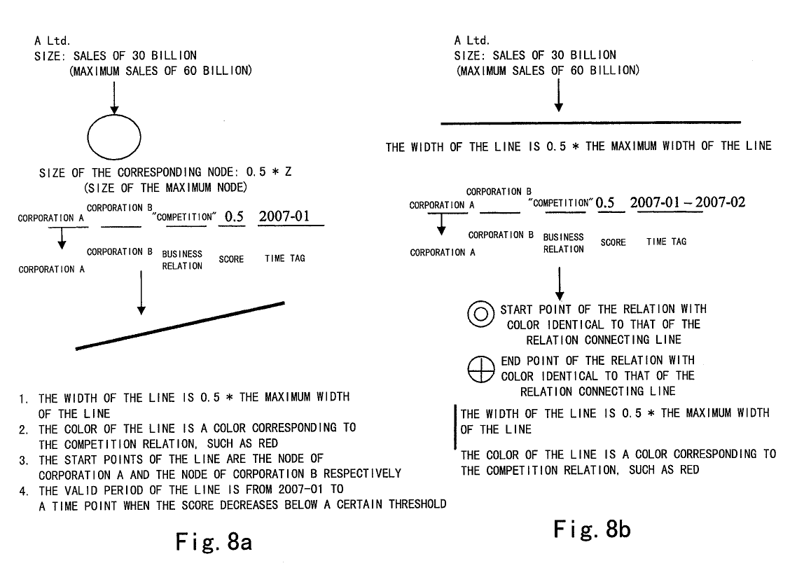

A basis graph generating unit 44 is provided for generating basic node information and connecting line information. FIGS. 8a and 8b show an example of generating a basis graph. There are at least two manners in which the nodes and connecting lines are constructed. In a first manner (as shown in FIG. 8a), the nodes are based on the corporation information, and the connecting line information is based on the corporation business relation entities. At the same time, the importances of the corporations correspond to the sizes of the nodes, the scores of the corporation business relations correspond to the width or length parameters of the connecting lines, and the colors of the lines correspond to the types of the business relations. In a second manner (as shown in FIG. 8b), the starts of the business relations are used as the nodes, and the connecting lines may be categorized into corporation reference lines and event-start-associated lines. For the event-start-associated lines, the colors correspond to the corresponding business relations.

A graph additional information calculating unit 45 is provided for planning the layout of the view, and mainly carries out the following operation: 1) node position information calculating: determining the layout of the respective nodes and connecting lines to avoid intersecting and overlapping so that the three-dimensional coordinates of the respective nodes/connecting lines are finally obtained; 2) location information calculating: calculating locating information of the specific nodes or connecting lines in all the associated views with a result in a form of <object, view, position> stored into a table structure; 3) association information calculating: for the nodes and the corresponding connecting lines, calculating other background data information associated therewith, such as information on the events occurring at a certain time at the nodes, where the connecting lines correspond to the information on the news embodied in the certain time and the like; 4) level information calculating: dividing of the levels based on the corporation business relations; 5) partition information calculating: calculating which nodes and connecting lines belong to one group in a certain view, which may be mapped into the clusters of the graphs, certain event associated entity list or certain time interval associated entity list, and the like; and 6) preloading information calculating: calculating data descriptions to be preloaded of a certain view corresponding to a certain level and a certain partition entity group, which information will automatically start the data modules to be preloaded so as to improve the user experiences.

A view rendering engine 46 renders and generates the corresponding view based on the view cache and the basis and additional information of the graph which are generated by the basis graph generating unit 44 and the graph additional information calculating unit 45 respectively, and maps certain user event information into the certain region of the view based on the parsing result on the view task.

An interface presenting unit 47 outputs the result of the view rendering engine 46 onto the screen, and appropriately matches and maps the mouse event and the keyboard event into certain region of the view.

Further, when the entities are natural persons, there are human relations between persons. The types of the relations may be continuous relations such as friend, colleague, couple, lineal relative, collateral relative, opponent, superior/junior and supervision, and event-like relations such as marriage, bearing and divorce. Also, there must be certain importance between corresponding persons. An importance of a person may reflect his effect in the society. It is apparent from the embodiments with respect to the corporation business relations as described above that those skilled in the art may perform relation mining by using the above method and apparatus in the case that the entities are persons.

Also, the method according to the present invention is applicable to the international relations. The types of the international relations may be continuous relations such as ally relation, friendly relation and hostile relation, and event-like relations such as declaring war, breaking off diplomatic relation and merging. A corresponding importance of a nation reflects its effect in the world. The method according to the present invention is also applicable to the case that the entities are products. In this case, the relations between products may be continuous relations such as adscription and competition, and event-like relations such as substitute and upgrade. A corresponding importance of a product may reflect its share in the market. To sum up, after reading the embodiments (corporations, business relations) of the present invention, it is possible for those skilled in the art to apply the present invention to the entities and relations other than the corporations and business relations in a certain corresponding manner.

The present invention is described with reference to the preferred embodiments thereof. It is to be understood that, for those skilled in the art, various changes, replacements and additions may be made thereto without departing from the spirit and scope of the invention. Therefore, the scope of the present invention is not limited to those embodiments described above, and is only defined by the appended claims.

What is claimed is:

1. An entity relation mining apparatus, comprising:
a time-series entity relation extracting means for reading entity relation instances to generate time-series scored entity relations.

2. The entity relation mining apparatus according to claim 1, wherein the time-series entity relation extracting means further generates time-series comprehensive entity relation scores based on the generated time-series scored entity relations.

3. The entity relation mining apparatus according to claim 2, further comprising:
a time-series entity importance extracting means for reading the time-series comprehensive entity relation scores generated by the time-series entity relation extracting means to generate time-series entity importances.

4. The entity relation mining apparatus according to claim 2, further comprising:
an event detecting means for reading the time-series entity relations and the time-series comprehensive entity relation scores generated by the time-series entity relation extracting means to generate events.

5. The entity relation mining apparatus according to claim 3, further comprising:
an event detecting means for reading the time-series entity relations, the time-series comprehensive entity relation scores, and the time-series entity importances generated by the time-series entity relation extracting means and the time-series entity importance extracting means respectively to generate events.

6. The entity relation mining apparatus according to claim 1, further comprising:
a relation instance extracting means for reading text information data to generate the entity relation instances.

7. The entity relation mining apparatus according to claim 1, wherein the time-series entity relation extracting means comprises:
a time-series interpolating unit for calculating a score of an entity relation by interpolation for the entity relation within a prescribed time duration during which no entity relation occurs so that finally any one of continuous relations between any entities within the prescribed time duration has its score at any time point.

8. The entity relation mining apparatus according to claim 7, wherein the time-series entity relation extracting means further comprises at least one of:
an entity relation instance strength calculating unit for calculating a strength of an entity relation within a corresponding time unit, i.e., a score of the entity relation, according to each entity relation instance; and
an event-like relation and conflict processing unit for processing event-like relations to obtain the time-series scored entity relations.

9. The entity relation mining apparatus according to claim 7, wherein for a time duration between two adjacent time points where the entity relations occur, the time-series interpolating unit performs the interpolation on the scores of the entity relation in a manner that the scores linearly or exponentially attenuate or increase over time.

10. The entity relation mining apparatus according to claim 3, wherein the time-series entity importance extracting means comprises:
a graph creating unit for creating an undirected graph for entities within each time unit, wherein in the undirected graph, vertices are respective entities, and edges connecting the vertices have respective weights which are the comprehensive entity relation scores between the two entities; and
a graph node importance calculating unit for calculating an importance for each node, that is, the entity importance, using a graph node importance calculating method.

11. The entity relation mining apparatus according to claim 10, wherein the graph node importance calculating method is a Page Rank method or a HITS algorithm.

12. The entity relation mining apparatus according to claim 3, wherein the time-series entity importance extracting means comprises:
a graph creating unit for creating an undirected graph for entities within each time unit, wherein in the undirected graph, vertices are respective entities, and edges connecting the vertices have respective weights which are the comprehensive entity relation scores between the two entities; and
a graph node connectivity calculating unit for calculating an importance for each node, that is, the entity importance, using a graph node connectivity calculating method.

13. The entity relation mining apparatus according to claim 12, wherein the graph node connectivity calculating method is: calculating a sum of the number of the connections to each node or a sum of the weights of the connections to each node.

14. The entity relation mining apparatus according to claim 4, wherein the event detecting means comprises:
a rule-based event extracting unit, which detects all inputted data by using predefined rules related to the time-series entity relations and the time-series comprehensive entity relation scores, and outputs the events matching the predefined rules.

15. The entity relation mining apparatus according to claim 4, wherein the event detecting means comprises:
an entity exterior score calculating unit, which performs score calculations on auxiliary information to obtain exterior scores for the entities; and
a rule-based event extracting unit, which detects all inputted data by using predefined rules related to the time-series entity relations, the time-series comprehensive entity relation scores and the exterior scores for the entities, and outputs the events matching the predefined rules.

16. The entity relation mining apparatus according to claim 5, wherein the event detecting means comprises:
a rule-based event extracting unit, which detects all inputted data by using predefined rules related to the time-series entity relations, the time-series comprehensive entity relation scores and the time-series entity importances, and outputs the events matching the predefined rules.

17. The entity relation mining apparatus according to claim 5, wherein the event detecting means comprises:
an entity exterior score calculating unit, which performs score calculations on auxiliary information to obtain exterior scores for the entities; and
a rule-based event extracting unit, which detects all inputted data by using predefined rules related to the time-series entity relations, the time-series comprehensive entity relation scores, the time-series entity importances and the exterior scores for the entities, and outputs the events matching the predefined rules.

18. The entity relation mining apparatus according to claim 16, wherein for an acquisition event, the rule-based event extracting unit determines whether a full acquisition or a partial acquisition between two entities occurs based on the entity importances of the two entities upon acquisition and/or changes in the entity importances of the two entities after acquisition.

19. The entity relation mining apparatus according to claim 1, wherein the entities are corporations, and the relations are business relations.

20. The entity relation mining apparatus according to claim 19, further comprising:
a time-series Five Force analyzing means for generating time-series force data based on the time-series entity relations and the time-series entity importances.

21. The entity relation mining apparatus according to claim 20, wherein the time-series Five Force analyzing means comprises:
a trade dividing unit for dividing the inputted time-series entity relations and the time-series entity importances based on the required trades to output the time-series entity relations and the importances for individual trades; and
at least one of
a threat of entry analyzing unit for calculating the threat of entry at a given time t₀;
a power of supplier analyzing unit for calculating the power of supplier at the given time t₀;
a power of buyer analyzing unit for calculating the power of buyer at the given time t₀;
a competitive rivalry analyzing unit for calculating the competitive rivalry at the given time t₀; and
a threat of substitute analyzing unit for calculating the threat of substitute at the given time t₀.

22. The entity relation mining apparatus according to claim 21, wherein the threat of substitute analyzing unit obtains future potential all-round competitors by analyzing future competition trends, instead of calculating the threat of substitute at the given time t₀.

23. The entity relation mining apparatus according to claim 1, wherein the entities are products, persons or nations, and the relations are relations between products, persons or nations.

24. The entity relation mining apparatus according to claim 1, further comprising:
a visualizing means for generating a visualized interface based on at least one of the inputted time-series entity relations, the time-series comprehensive entity relation scores, the time-series entity importances, and the time-series force data.

25. The entity relation mining apparatus according to claim 24, wherein the visualizing means generates the visualized interface with nodes and connecting lines, wherein
each node represents an entity, and the connecting lines between the nodes represent the types and scores of the entity relations, wherein the sizes of the nodes correspond to the importances of the entities, the width or length parameters of the connecting lines correspond to the scores of the entity relations, and the colors of the connecting lines correspond to the types of the entity relations.

26. The entity relation mining apparatus according to claim 24, wherein the visualizing means generates the visualized interface with nodes and connecting lines, wherein
the starts of the relations are used as the nodes, the connecting lines are categorized into entity reference lines and event-start-associated lines, wherein the colors of the event-start-associated lines correspond to the types of the entity relations.

27. An entity relation mining method, comprising:
a time-series entity relation extracting step of reading entity relation instances to generate time-series scored entity relations.

28. The entity relation mining method according to claim 27, wherein in the time-series entity relation extracting step, time-series comprehensive entity relation scores are further generated based on the generated time-series scored entity relations.

29. The entity relation mining method according to claim 28, further comprising:
a time-series entity importance extracting step of reading the time-series comprehensive entity relation scores generated in the time-series entity relation extracting step to generate time-series entity importances.

30. The entity relation mining method according to claim 28, further comprising:
an event detecting step of reading the time-series entity relations and the time-series comprehensive entity relation scores generated in the time-series entity relation extracting step to generate events.

31. The entity relation mining method according to claim 29, further comprising:
an event detecting step of reading the time-series entity relations, the time-series comprehensive entity relation scores, and the time-series entity importances generated in the time-series entity relation extracting step and the time-series entity importance extracting step respectively to generate events.

32. The entity relation mining method according to claim 27, further comprising:
a relation instance extracting step of reading text information data to generate the entity relation instances.

33. The entity relation mining method according to claim 27, wherein the time-series entity relation extracting step comprises:
a time-series interpolating sub-step of calculating a score of an entity relation by interpolation for the entity relation within a prescribed time duration during which no entity relation occurs so that finally any one of continuous relations between any entities within the prescribed time duration has its score at any time point.

34. The entity relation mining method according to claim 33, wherein the time-series entity relation extracting step further comprises at least one of:
an entity relation instance strength calculating sub-step of calculating a strength of an entity relation within a corresponding time unit, i.e., a score of the entity relation, according to each entity relation instance; and
an event-like relation and conflict processing sub-step of processing event-like relations to obtain the time-series scored entity relations.

35. The entity relation mining method according to claim 33, wherein in the time-series interpolating sub-step, for a time duration between two adjacent time points where the entity relations occur, the interpolation on the scores of the entity relation is performed in a manner that the scores linearly or exponentially attenuate or increase over time.

36. The entity relation mining method according to claim 29, wherein the time-series entity importance extracting step comprises:
a graph creating sub-step of creating an undirected graph for entities within each time unit, wherein in the undirected graph, vertices are respective entities, and edges connecting the vertices have respective weights which are the comprehensive entity relation scores between the two entities; and
a graph node importance calculating sub-step of calculating an importance for each node, that is, the entity importance, using a graph node importance calculating method.

37. The entity relation mining method according to claim 36, wherein the graph node importance calculating method is a Page Rank method or a HITS algorithm.

38. The entity relation mining method according to claim 29, wherein the time-series entity importance extracting step comprises:
a graph creating sub-step of creating an undirected graph for entities within each time unit, wherein in the undirected graph, vertices are respective entities, and edges connecting the vertices have respective weights which are the comprehensive entity relation scores between the two entities; and
a graph node connectivity calculating sub-step of calculating an importance for each node, that is, the entity importance, using a graph node connectivity calculating method.

39. The entity relation mining method according to claim 38, wherein the graph node connectivity calculating method is: calculating a sum of the number of the connections to each node or a sum of the weights of the connections to each node.

40. The entity relation mining method according to claim 30, wherein the event detecting step comprises:
a rule-based event extracting sub-step of detecting all inputted data by using predefined rules related to the time-series entity relations and the time-series comprehensive entity relation scores, and outputting the events matching the predefined rules.

41. The entity relation mining method according to claim 30, wherein the event detecting step comprises:
an entity exterior score calculating sub-step of performing score calculations on auxiliary information to obtain exterior scores for the entities; and
a rule-based event extracting sub-step of detecting all inputted data by using predefined rules related to the time-series entity relations, the time-series comprehensive entity relation scores and the exterior scores for the entities, and outputting the events matching the predefined rules.

42. The entity relation mining method according to claim 31, wherein the event detecting step comprises:
a rule-based event extracting sub-step of detecting all inputted data by using predefined rules related to the time-series entity relations, the time-series comprehensive entity relation scores and the time-series entity importances, and outputting the events matching the predefined rules.

43. The entity relation mining method according to claim 31, wherein the event detecting step comprises:
an entity exterior score calculating sub-step of performing score calculations on auxiliary information to obtain exterior scores for the entities; and
a rule-based event extracting sub-step of detecting all inputted data by using predefined rules related to the time-series entity relations, the time-series comprehensive entity relation scores, the time-series entity importances and the exterior scores for the entities, and outputting the events matching the predefined rules.

44. The entity relation mining method according to claim 42, wherein in the rule-based event extracting sub-step, for an acquisition event, it is determined whether a full acquisition or a partial acquisition between two entities occurs based on the entity importances of the two entities upon acquisition and/or changes in the entity importances of the two entities after acquisition.

45. The entity relation mining method according to claim 27, wherein the entities are corporations, and the relations are business relations.

46. The entity relation mining method according to claim 45, further comprising:
a time-series Five Force analyzing step of generating time-series force data based on the time-series entity relations and the time-series entity importances.

47. The entity relation mining method according to claim 46, wherein the time-series Five Force analyzing step comprises:
a trade dividing sub-step of dividing the inputted time-series entity relations and the time-series entity importances based on the required trades to output the time-series entity relations and the importances for individual trades; and
at least one of
a threat of entry analyzing sub-step of calculating the threat of entry at a given time t₀;
a power of supplier analyzing sub-step of calculating the power of supplier at the given time t₀;
a power of buyer analyzing sub-step of calculating the power of buyer at the given time t₀;
a competitive rivalry analyzing sub-step of calculating the competitive rivalry at the given time t₀; and
a threat of substitute analyzing sub-step of calculating the threat of substitute at the given time t₀.

48. The entity relation mining method according to claim 47, wherein in the threat of substitute analyzing sub-step, future potential all-round competitors are obtained by analyzing future competition trends, instead of calculating the threat of substitute at the given time t₀.

49. The entity relation mining method according to claim 27, wherein the entities are products, persons or nations, and the relations are relations between products, persons or nations.

50. The entity relation mining method according to claim 27, further comprising:
a visualizing step of generating a visualized interface based on at least one of the inputted time-series entity relations, the time-series comprehensive entity relation scores, the time-series entity importances, and the time-series force data.

51. The entity relation mining method according to claim 50, wherein in the visualizing step, the visualized interface is generated with nodes and connecting lines, wherein
each node represents an entity, and the connecting lines between the nodes represent the types and scores of the entity relations, wherein the sizes of the nodes correspond to the importances of the entities, the width or length parameters of the connecting lines correspond to the scores of the entity relations, and the colors of the connecting lines correspond to the types of the entity relations.

52. The entity relation mining method according to claim 50, wherein in the visualizing step, the visualized interface is generated with nodes and connecting lines, wherein
the starts of the relations are used as the nodes, the connecting lines are categorized into entity reference lines and event-start-associated lines, wherein the colors of the event-start-associated lines correspond to the types of the entity relations.
